(19) United States
(12) Patent Application Publication
(10) Pub. No.: US 2021/0115628 A1
(43) Pub. Date: Apr. 22, 2021

(54) People Rivers

(71) Applicant: Robert S. Carney, JR., Minneapolis, MN (US)

(72) Inventor: Robert S. Carney, JR., Minneapolis, MN (US)

(21) Appl. No.: 16/654,530

(22) Filed: Oct. 16, 2019

(51) Int. Cl. E01C 1/00

(52) U.S. Cl. CPC E01C 1/002

(57) ABSTRACT

A multi-level, elevated system for providing urban areas with a grid of transportation and transit Right-Of-Ways for automated-driving vehicles as large as a mobility bus of an approximate twenty five foot length, and for human-driven ambulances and police vehicles with the same size limit; all vehicles having fully loaded weight limits—allowing such vehicles to move by means of vehicle elevators back and forth in connecting with existing ground level transportation and transit Right-Of-Ways, and optionally to be driven manually when on such ground level existing Right-Of-Ways. Additional levels include: a Not-a-wall architecture level, a utilities level, a parks level, a housing level, a heavy lift level, an energy roof level, and an airplane level. The underlying idea is to develop what might be called “people rivers”—grids of infrastructure that allow people, goods, commodities and utilities, ground and train-air hybrid system, and even housing, to flow along these grids in the same way that water flows in rivers. One key design element of the present invention is Not-a-wall design and architecture. Because almost the entire infrastructure of the present invention will be elevated, people to move freely and pleasantly through urban environments that will become increasing less congested as transportation moves above ground. Because the present invention will be built and maintained almost entirely with automated means, the real economic cost of transit and housing will drop drastically, allowing basic human needs to be met economically for low-income people; however, through the judicious use of taxation, the investment value of all current infrastructure, including housing stock, will not be impaired. Because the utilities level can be integrated with existing infrastructure, over time the maintenance and expansion cost of utility service will also be greatly reduced; the ability to separate potable and waste water will also result in many cases in major environmental improvements. We also face a critical ethical issue: with our ability to automate virtually everything, is it moral or ethical to continue to build transportation and other systems, and elements of systems, that we know will kill people? A central premise of the present invention is that with today's capabilities, it is no longer ethically or morally justifiable to do this.

### BACKGROUND OF THE INVENTION

Cities and transportation systems have been established over centuries, serving both economic functions as hubs for commercial activity, and as a means of defense for a community. Physical walls were an important element of defense in earlier centuries. More recently, transportation systems themselves have taken on the character of walls, both providing economic infrastructure to support societies with large spending dedicated to defense, and establish what can be thought of moving walls of vehicles—these “vehicle walls” are in fact barriers to movement between the neighborhoods and communities they separate . . . whether we want them to be or not. Inevitably, as both cities and these “vehicle walls” have grown, in many cases beyond their temporal useful design periods, congestion and gridlock have resulted. This reduces both economic efficiency and the quality of life. Increasing housing density believed necessary to support transit systems is seen by many as negatively affecting the quality of life in many urban neighborhoods, both from overbuilding per se, and from increasing congestion.

### BRIEF DESCRIPTION OF THE INVENTION

With automated everything as the upcoming driving character of infrastructure and work in the twenty first century, an opportunity presents itself to develop what might be called “people rivers”—grids of infrastructure that allow people, goods, commodities and utilities, ground and train-air hybrid system, and even housing, to flow along these grids in the same way that water flows in rivers. A primary level will be a grid of transportation and transit Right-Of-Ways for automated-driving vehicles as large as a mobility bus of approximate length of twenty five feet, and for human-driven ambulances and police vehicles with the same size limit, allowing such vehicles to move by means of vehicle elevators back and forth in connecting with existing ground level transportation and transit Right-Of-Ways, and optionally to be driven manually when on such ground level existing Right-Of-Ways. Additional levels include: a Not-a-wall architecture level, a utilities level, a parks level, a housing level, a heavy lift level, an energy roof level, and an airplane level.

One key aspect of concentrating the growth of both the situation and the flow of people, goods, commodities and utilities, ground and train-air hybrid system, and housing, is the idea of Not-a-wall architecture. Very simply, when everything is put at elevated levels, there are no barriers to the movement of people at ground level from one neighborhood to the next. Beyond that point, a judicious use of landscape architecture makes it possible plant trees in a way that a grid of “people rivers”—structures rising to over twenty stories in height or more, to be largely if not entirely invisible to the people living in neighborhoods more than a block or so away from the nearest “people river” right of way. Finally, the combination of modularization, automated systems for construction and maintenance, and automated transit vehicles, allows the present invention to render urban design that combines significantly greater density, and its related economically sustainable transit, with neighborhoods that not only retain their character and quality of life, but actually tend towards less local traffic and more livable communities.

The overall approach to urbanization offered by the present invention offers the prospect of both a dramatic increase of a society's ability to provide affordable transit and housing, while maintaining the investment value of existing infrastructure. Because the utilities level can be integrated with existing infrastructure, over time the maintenance and expansion cost of utility service will also be greatly reduced; the ability to separate potable and waste water will also result in many cases in major environmental improvements.

### BRIEF DESCRIPTION OF THE DRAWINGS

FIG. 1 is a side view illustrating the basic levels of a freeway-wide full installation between intersections

FIG. 2 is an isometric view illustrating a freeway-wide full installation framework between intersections

FIG. 3 is a side view illustrating basic ground transportation level sublayers

FIG. 4 is a side view illustrating a housing level

FIG. 4a is a top view illustrating a layout for a housing level

FIG. 5 is a side view illustrating a scheme for a heavy lift level

FIG. 5a is a top view illustrating a scheme for a heavy lift level, having a moving lift module

FIG. 6 is a top view illustrating an energy roof level

FIG. 7 is a side view illustrating a starter layout for an airplane level

FIG. 7a is a top view illustrating a layout for an airplane level

FIG. 8 is a top view of all four approaches and a four-way intersection of two freeway-wide full installations of the ground transportation level, illustrating connecting ramp zones and the freeway-wide full intersection zone

FIG. 8a is a top view of a section of the lower thruway level of a freeway-wide full installation approaching an intersection

FIG. 8b is a top view of a section of the upper thruway level of a freeway-wide full installation approaching an intersection

FIG. 8c is a top view of turning lanes for one quadrant of a turning level of a freeway-wide full installation intersection

FIG. 8d is a top view of turning lanes for all quadrants of a turning level of a freeway-wide full installation intersection

FIG. 8d-1 is a top view of an enhanced layout for turning lanes for all quadrants of a turning level of a freeway-wide full installation intersection

FIG. 8e is a top view of a four-way stopping level of a freeway-wide full installation intersection

FIG. 8f is a side view of connecting ramp lanes for a section of the levels of a freeway-wide full installation approaching an intersection

FIG. 8g is a top view of the connecting ramp lane to the turning level of a freeway-wide full installation between intersections

FIG. 8h is a top view of the connecting ramp lane a four-way stopping level of a freeway-wide full installation between intersections

FIG. 8i is a side view of sublevels at a four-way intersection of two freeway-wide full installations of the ground transportation level

FIG. 9 is a top view of all four approaches and a four-way intersection of two Narrower starter installations of the ground transportation level, illustrating connecting ramp zones and the freeway-wide full intersection zone

FIG. 9f is a side view of connecting ramp lanes for a section of the levels of a narrower starter installation approaching a four-way intersection

FIG. 9i is a side view of sublevels at a four-way intersection of two narrower starter installations of the ground transportation level

### DETAILED DESCRIPTION OF A PREFERRED EMBODIMENT OF THE PRESENT INVENTION

The present invention comprises a framework for both greatly expanding a society's ability to provide transportation, housing and utilities, while at the same time preserving and enhancing the quality of life in existing built urban environments. The general idea is a system of “people rivers”—networks similar to current transportation networks, but where in the coming age of automation, people, utilities, goods, and even housing can literally flow autonomously.

One key design element of the present invention is Not-a-wall architecture. Almost the entire infrastructure of the present invention will be elevated—allowing people to move freely and pleasantly through urban environments that will become increasing less congested as transportation moves above ground. Today, freeways and major arterial rights of way are dividing lines between neighborhoods—they are walls of moving vehicles, but unlike rigid walls they not only generally prevent the passage of people, they also kill and injure people trying to cross them. This situation will slowly fade as the present invention is implemented. A critical ethical issue is raised at this point: with our ability to automate virtually everything, is it ethical to continue to build systems and elements of systems that we know will kill people? A central premise of the present invention is that with today's capabilities, it is no longer ethically or morally justifiable to continue to do this.

Another key design element of the present invention is that all structural elements are to be organized such that over time they can be constructed, installed, maintained and removed entirely or almost entirely by automated means. This will be a principal economic advantage offered by the present invention.

The Rights-Of-Ways for full installations of the present invention—the functional equivalent of major arterials—will be typically spaced at distance of one to two miles—sometimes or more—thinking generally of a grid. However, starter, or smaller scale installations will be spread such that, again thinking of a grid, the distance from one right of way to the next parallel right of way will often if not typically be a mile or less—half a mile may be a more standard spacing.

The present invention further comprises a grid of above ground level, multi-level Right-Of-Ways, further comprising intersections; each said Right-Of-Way further comprises a Not-a-wall architecture level, a utilities level, and a transportation level. For full installations, the typical levels will be, in order from the ground up: the Not-a-wall architecture level, a utilities level, a ground transportation (not flying) level, a parks level, a housing layer, a heavy lift level, an energy roof level, and an airplane level. For starter, or smaller scale installations, the starting point will typically be the ground transportation level, with space left below it for the implementation of the utilities level as soon as it becomes feasible, and with a parks level initially consisting of an all-weather (enclosable in winter) right of way for pedestrians, bikes, scooters, segways and so forth. Vehicle elevators link the transportation level to existing road infrastructure at ground level; these can move up to a dozen vehicles up and down quickly, at one lift. Only vehicles capable of automated driving will be allowed to use the system; ambulances and police cars—automated or human driven—will also be permitted, but not heavy fire equipment. Vehicle length will be limited to approximately twenty five feet; vehicles will also have fully loaded weight limits such as to reduce the required supported vehicle weight to an optimal level.

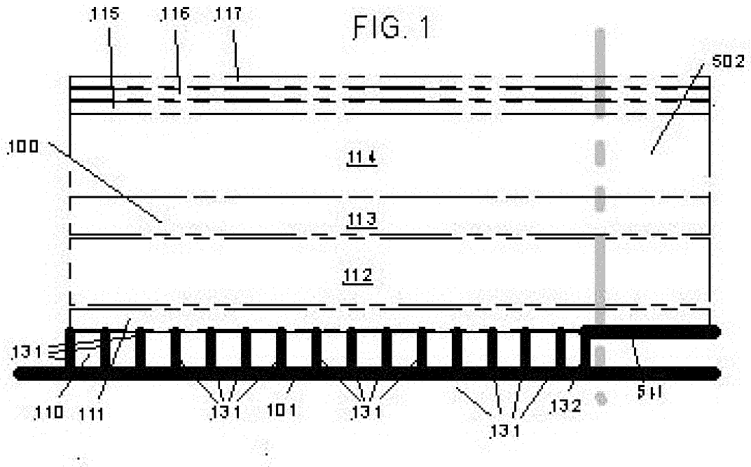

FIG. 1 is a side view illustrating the basic levels of a freeway-wide full installation between intersections of the present invention; the levels described above, comprising a freeway-wide full installation, 100, a ground level, 101, a Not-a-wall architecture level, 110, a utilities level, 111, a ground transportation level, 112, a parks level, 113, a housing level, 114, a heavy lift level, 115, an energy roof level, 116, an airplane level, 117, and a full installation intersection zone, 502. Regarding the Not-a-wall architecture level, this will be understood to comprise a structure of vertical beams or columns, such that everything above the structure is supported by it, and that the structure accommodates all current ground-level activities and structures—subject to the removal of some existing structures by the use of eminent domain if needed and appropriate. As we move into the future—the basic idea of Not-a-wall architecture, and Not-a-wall structures of the present invention, is to allow people and creatures to move freely and safely at ground level, unrestrained by the structures of the present invention.

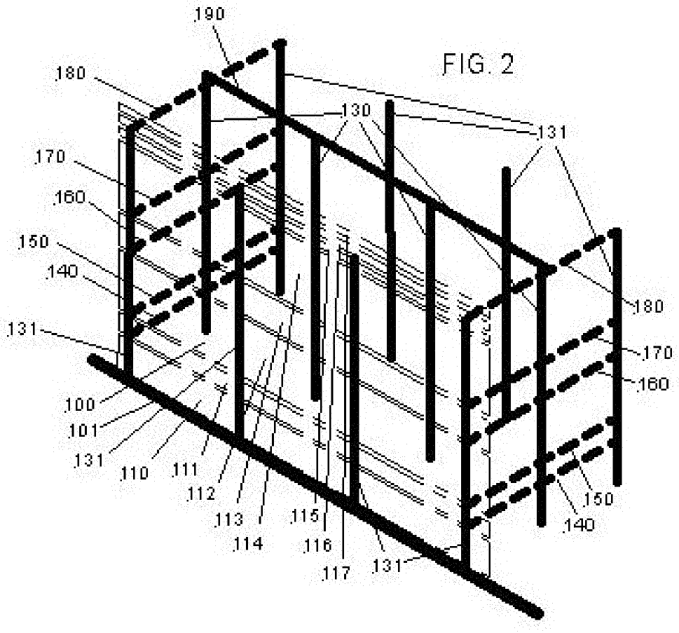

FIG. 2 is an isometric view illustrating a freeway-wide full installation framework between intersections of the present invention, comprising a freeway-wide full installation, 100, a ground level, 101, a Not-a-wall architecture level, 110, a utilities level, 111, a ground transportation level, 112, a parks level, 113, a housing level, 114, a heavy lift level, 115, an energy roof level, 116, an airplane level, 117, central vertical columns, 130, side vertical columns, 131, utilities cross beams, 140, ground transportation cross beams, 150, parks cross beams, 160, housing cross beams, 170, heavy lift/energy roof cross beams, 180, and an airplane level central track, 190. Cross beams are only illustrated at each end, but it will be understood that all vertical columns will have corresponding cross beams. The heights of the cross beams are adjustable, to allow additional levels to be added, and/or expanded, and in some cases removed, as needed over time. There can be sublayers, or sublevels, within each level, with associated sub-cross beams; generally various structures of depending horizontal support can be rendered as needed.

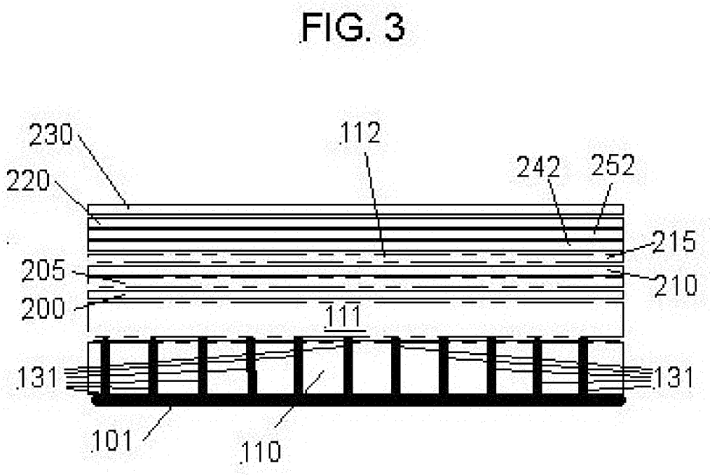

FIG. 3 is a side view illustrating basic ground transportation level sublayers, or sublevels, of the present invention, comprising a ground level, 101, a Not-a-wall architecture level, 110, a utilities level, 111, a ground transportation level, 112, a four-way stopping level, 200, a reserved—second four-way stopping level, 205, a turning level, 210, a reserved—second turning level, 215, a first lower thruway level, 220, carrying multiple lanes of traffic in a first direction, a first upper thruway level, 230, carrying multiple lanes of traffic in the opposite direction to the said first lower thruway level 220, a second lower thruway level, 242, carrying multiple lanes of traffic in a first direction, and a second upper thruway level, 252, carrying multiple lanes of traffic in an opposite direction to the said second lower thruway level 242. Referring to FIG. 2, as needed, additional supporting structure depending on the structure of FIG. 2 can be added; referring now to FIG. 3, the supporting structure and the various sublayers, or sublevels, can be adjusted over time as needed.

Referring to FIG. 1, while there is no separate figure illustrating the elements of the parks level, 113, this is because of the very wide variety of possible ways in which this can be rendered. The presence of a parks level is a way to both connect existing park infrastructure to embodiments of the present invention in major metropolitan areas, and to promote healthier living by making it practical for people to use bicycles, scooters, horses (why not!), and other means (in some cases not yet invented), in a weather sheltered parks level for much or most of their transportation needs.

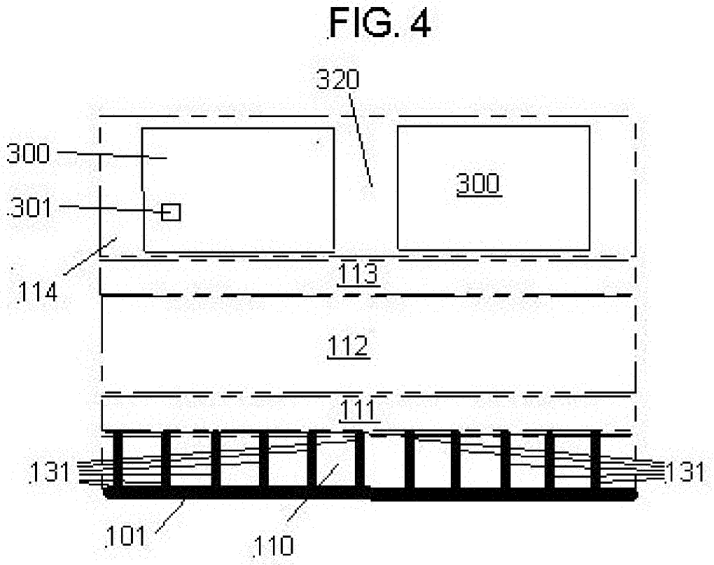

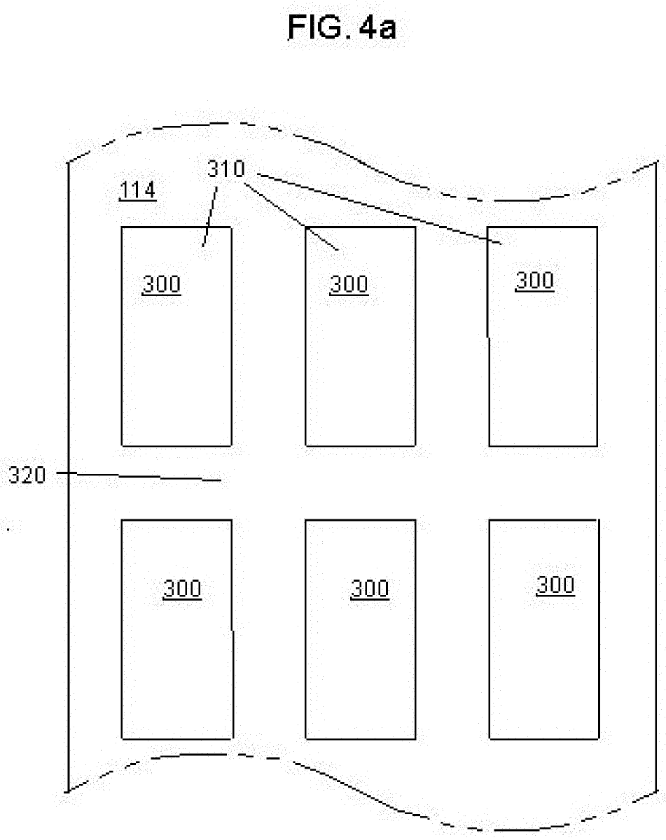

FIG. 4 is a side view illustrating a housing level of the present invention, comprising a ground level, 101, a Not-a-wall architecture level, 110, a utilities level, 111, a ground transportation level, 112, a parks level, 113, a housing level, 114, a housing structure, 300, a housing structure module, 301, and a housing structure gap, 320. Housing structures will be built with a module supporting framework, such that individual modules, illustrated by housing structure module 301, can be both installed, and easily moved from one location to another, using means provided by the heavy lift level. It will be understood that housing is a generic term; modules for all kinds of different purposes can be included as long as they conform to the dimensional and operational design specifications of standard housing structures. Those specifications and standards will include automated means to connect and disconnect utilities from modules.

FIG. 4a is a top view illustrating a basic layout for a housing level of the present invention, comprising a housing level, 114, housing structures, 300, which can be organized into housing rows, 310, and the said housing rows having a housing structure gap, 320, both for aesthetic reasons, and to facilitated the automated installation, removal, and moving of housing structure modules using means provided by the heavy lift level. It should be noted that due to the elevated location of the housing level, all outward facing views will be highly desirable. It should also be noted that both the inherent economies from using highly modularized construction techniques, and automation to build, maintain and move units, offers the prospect of providing an abundance of affordable housing for people who need it. As a person's earnings increase above the level providing for basic needs, the pricing of housing available in the present invention should include an economic component designed both to ensure that this new form of housing will not have a negative effect on the values of existing housing and all existing infrastructure. As a practical matter, the result will amount to a substantial source of new tax revenue. This is a good thing.

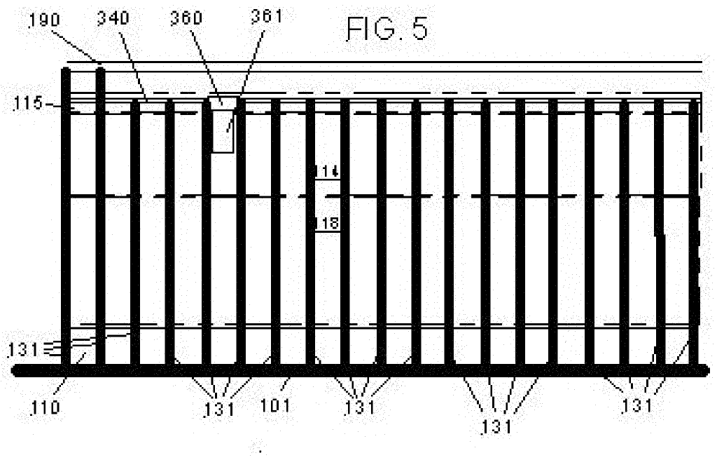

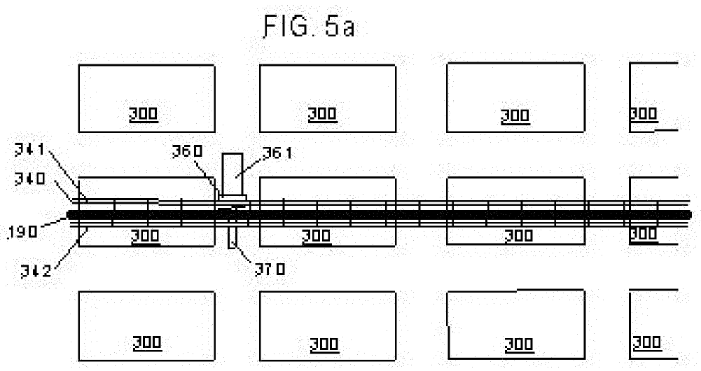

FIG. 5 is a side view illustrating a scheme for a heavy lift level of the present invention, comprising a ground level, 101, a Not-a-wall architecture level, 110, a housing level, 114, a heavy lift level, 115, other lower levels, 118, side vertical columns, 131, an airplane level central track, 190, a heavy lift track, 340, an extensible moving lift module, 360, and a forklift structure, 361.

FIG. 5a is a top view illustrating a scheme for a heavy lift level, having a moving lift module of the present invention, comprising an airplane level central track, 190, a housing structure, 300, a heavy lift track, 340, a first heavy lift track, 341, a second heavy lift track, 342, an extensible moving lift module, 360, a forklift structure, 361, and a pivoting extensible counterweight, 370.

The basic function of the extensible moving lift module, 360, is to install, and remove for relocation or recycling, housing modules. The moving lift module, 360, further comprises an extensible and pivotable forklift structure, 361, which can install and remove for relocation housing modules to and from housing structures, 300. The forklift structure will have extensible forks and, referring now to FIG. 4, can raise or lower housing structure modules, 301, over the entire height of the housing structures, 300. The extensible counterweight, 370, is used to stabilize the structure when it comprises a depending housing module when it is at a substantial distance from a heavy lift track, 340. The extensible moving lift module, 360, will typically be strong enough to support, raise and lower a housing module weighing a number of tons, when it is at the furthest distance from the central heavy lift track. It will be understood that over time, engineering and design standards will be developed for the means provided by the heavy lift level. It is anticipated that over time, performance gradations of a range of moving lift modules will be developed. Because the moving lift modules are on a heavy lift track, 340, they can move housing modules over long distances—the intention is to cover the entire service grid area of large metropolitan areas comprising rights of way with, now referring to FIG. 5, a heavy lift level, 115. Over time, means will be developed to ship housing modules over longer distances, including worldwide, with the use of standard shipping containers used in international trade. Means will also be developed to transfer housing modules, referring now to FIG. 5a, back and forth between a first heavy lift track, 341, a second heavy lift track, 342, such that some sections of a right of way of the present invention need have only one heavy lift track, rather than two. It may eventuate that most moving activity on the heavy lift tracks will occur during late night and early morning hours.

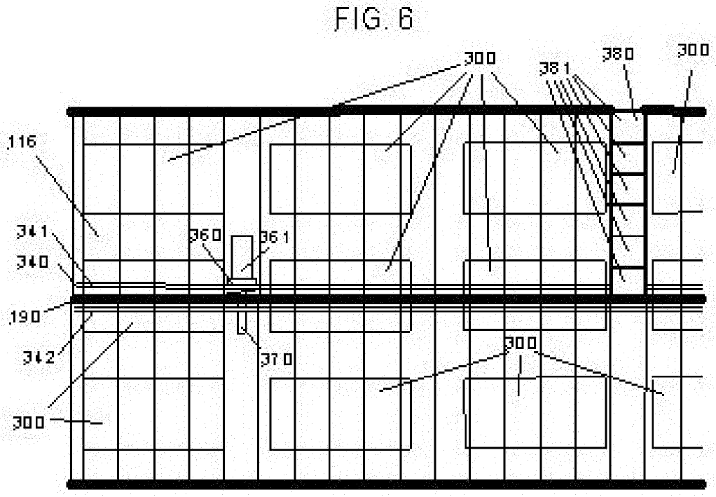

FIG. 6 is a top view illustrating an energy roof level of the present invention, comprising an energy roof level, 116, an airplane level central track, 190, a first heavy lift track, 341, a second heavy lift track, 342, an extensible moving lift module, 360, a forklift structure, 361, a pivoting extensible counterweight, 370, an energy roof panel module, 380, and an energy roof positionable panel section, 381. Energy roofs are an option for all rights of way—in addition to energy they can also provide shelter from the elements; snow removal systems can be included. Energy roof positionable panel sections, 381, can be for heating and/or electric generation. Designs can include the ability to use means from the heavy lift level to automatically secure and/or remove and store energy roof panel modules, 380, in anticipation of severe weather.

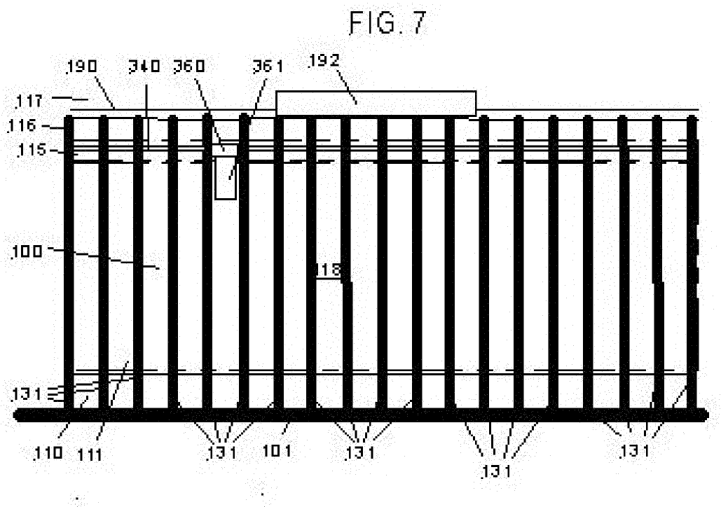

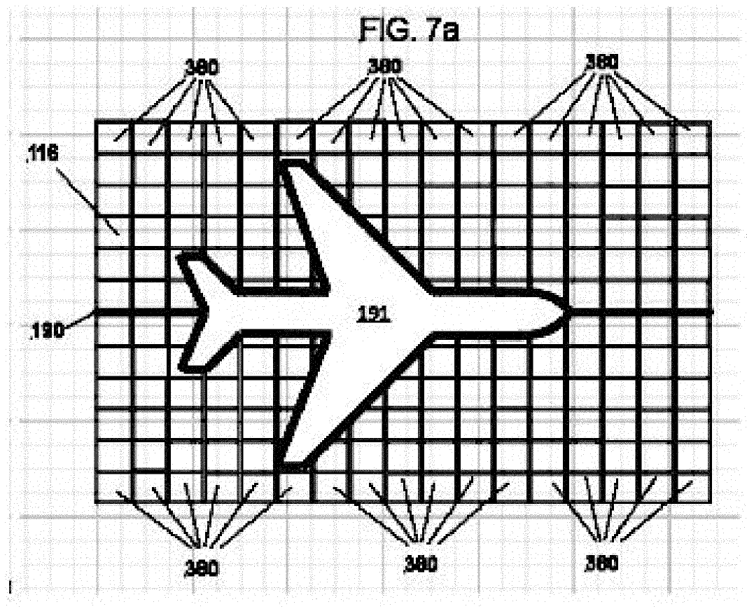

FIG. 7 is a side view illustrating a starter layout for an airplane level of the present invention, comprising a heavy lift level, 115, an energy roof level, 116, an airplane level, 117, other lower levels, 118, side vertical columns, 131, an airplane level central track, 190, an airplane power and mounting unit, 192, a heavy lift track, 340, an extensible moving lift module, 360, and a forklift structure, 361.

FIG. 7a is a top view illustrating a layout for an airplane level of the present invention, comprising an energy roof level, 116, an airplane level central track, 190, an airplane, 191, and energy roof panel sections, 380.

Over time, it is anticipated that aircraft will become an increasingly important element in the practice of the invention. Referring now to FIG. 7, airplane power and mounting units, 192, can be used to mount and move all kinds of aircraft, including large jets, to and fro within large metropolitan areas, at speeds of up to 200 miles per hour or more, making it possible to eliminate aircraft noise from urban environments. Over time, both dual level airplane tracks, and designs for what will amount to a kind of “flying train”—using the lift of wings to reduce the load on the track system—can be developed, to allow a hybrid of air and train service to connect large metropolitan areas with mid-sized and small towns, and rural areas. Making this an integral part of the current invention will be a vital consolidation of the entire transportation sector. Economic and quality-of-life opportunities abound for exurban and rural areas.

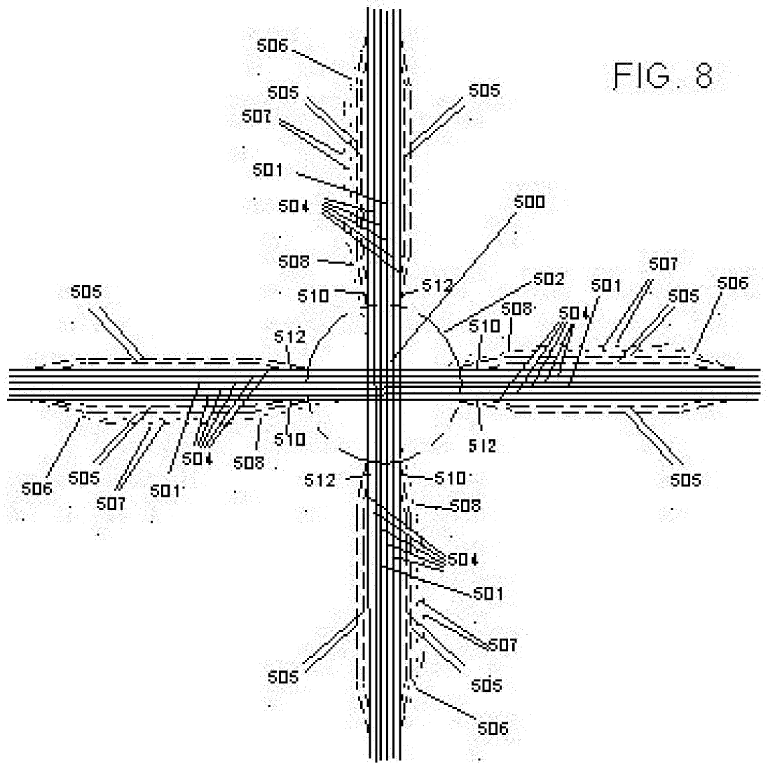

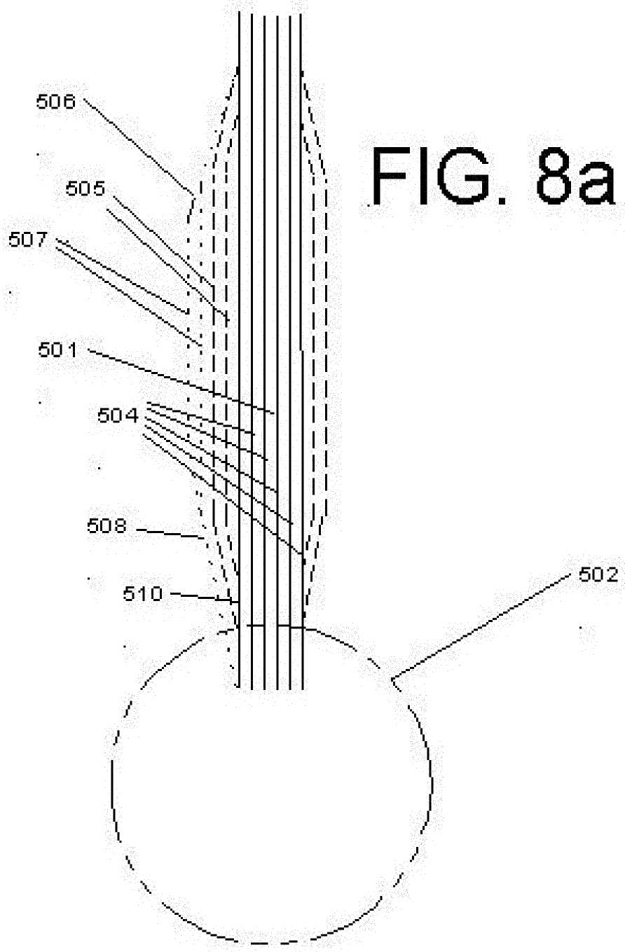

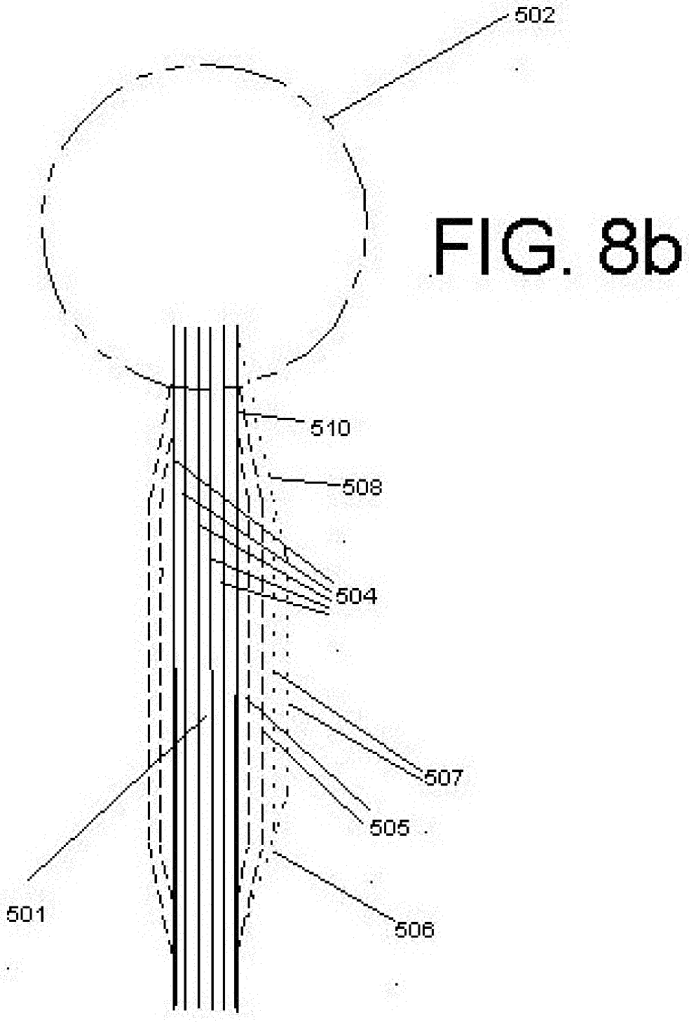

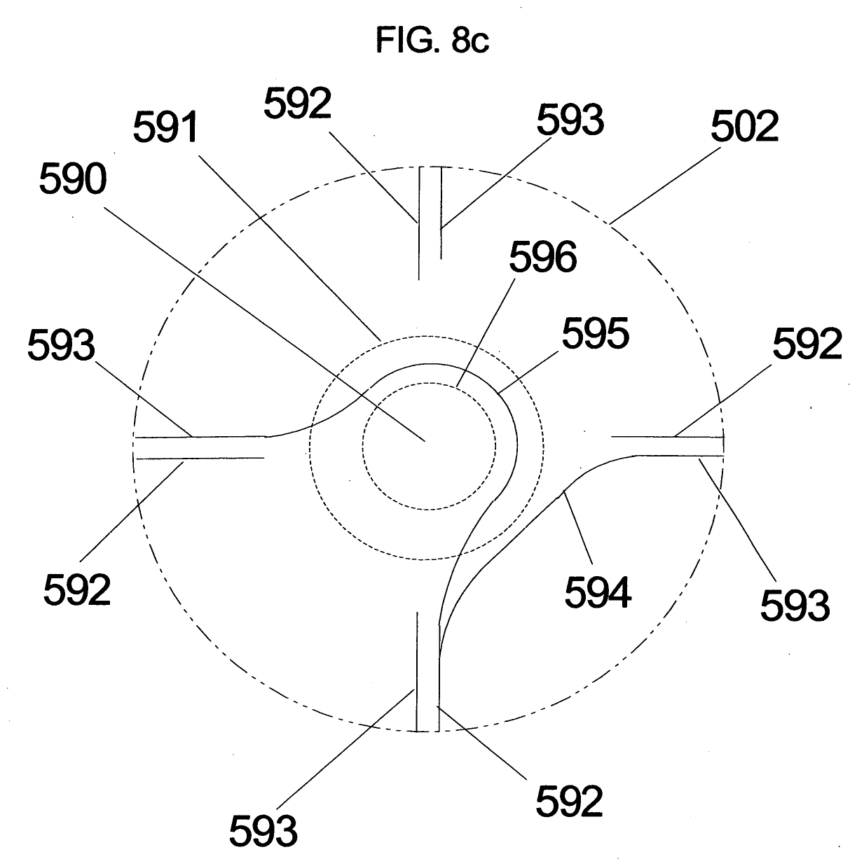

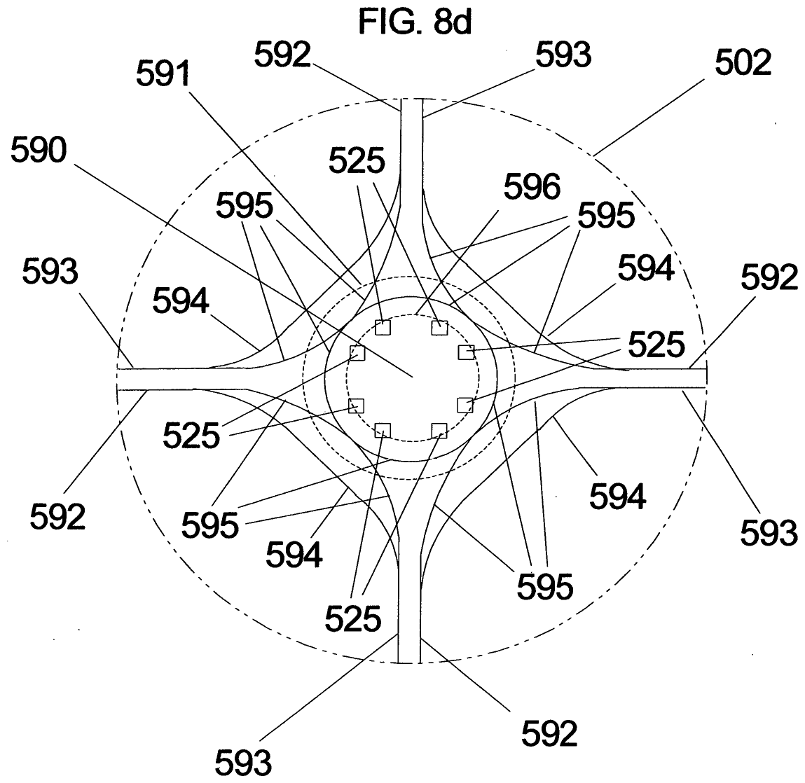

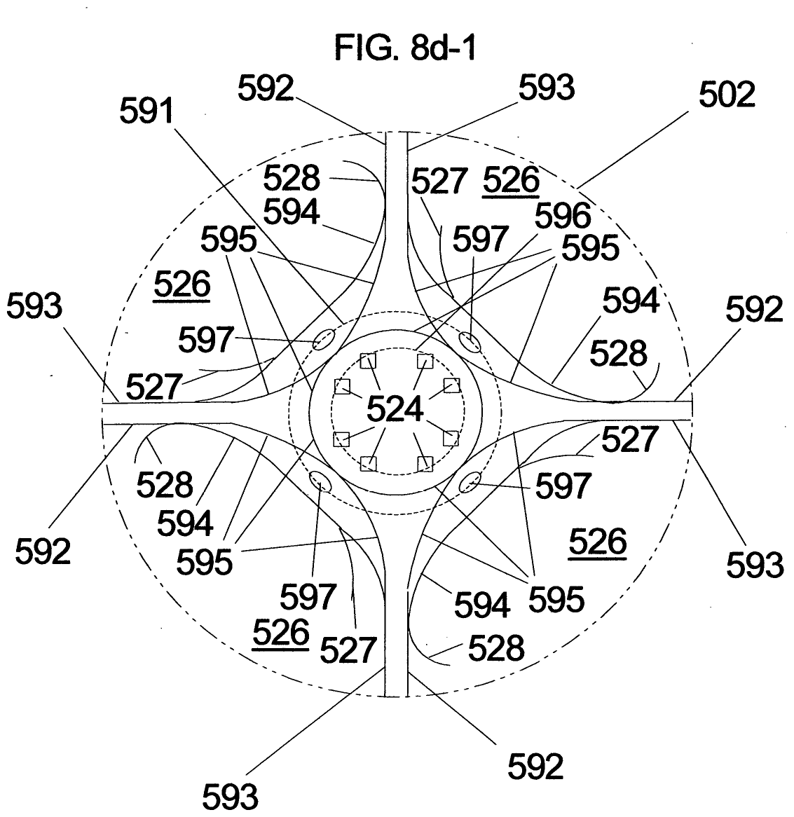

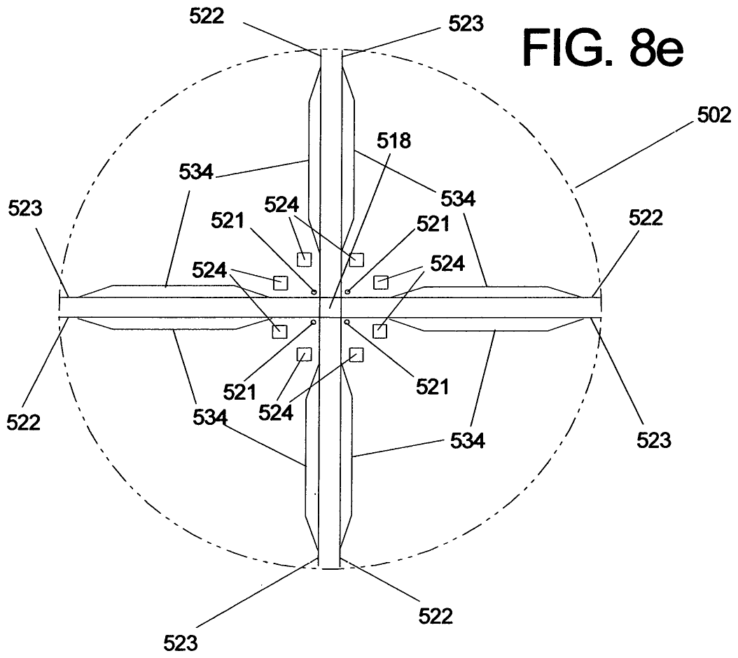

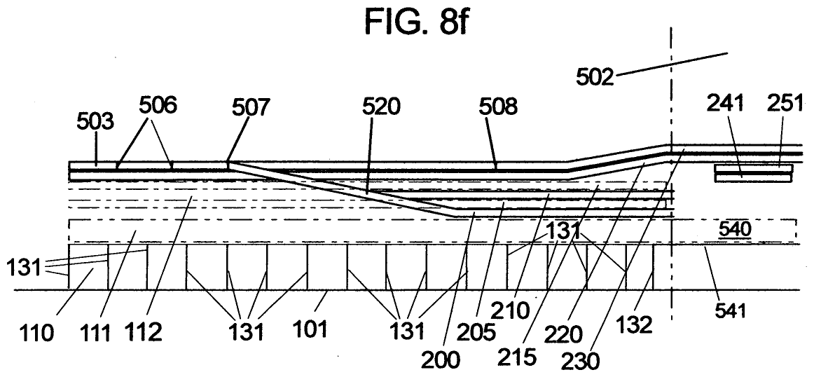

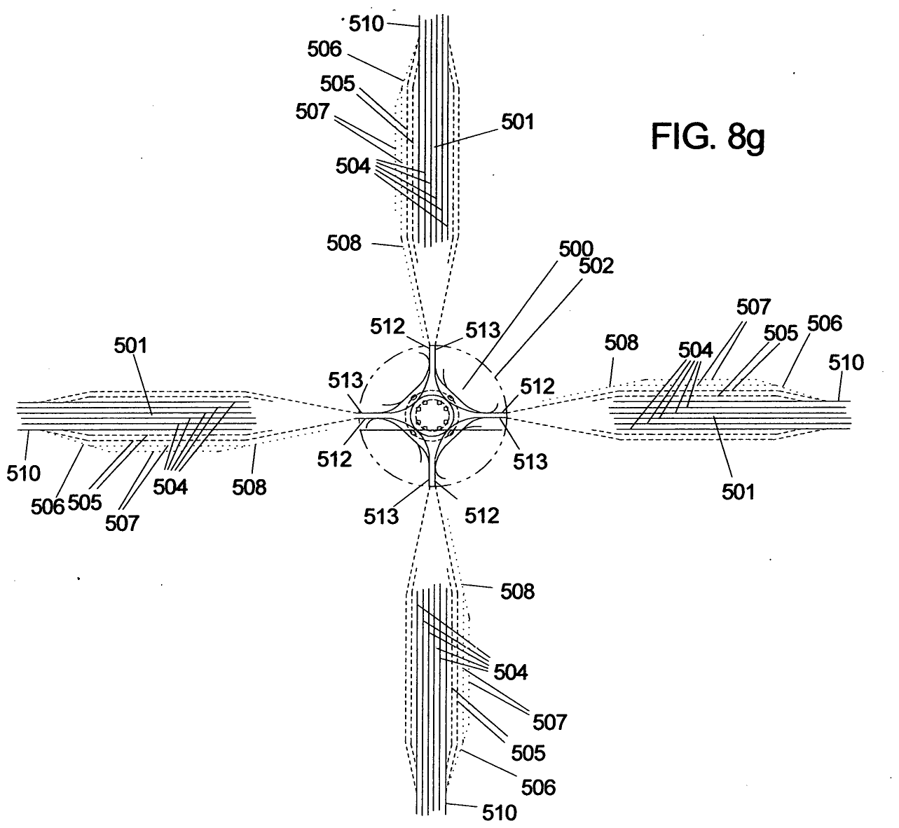

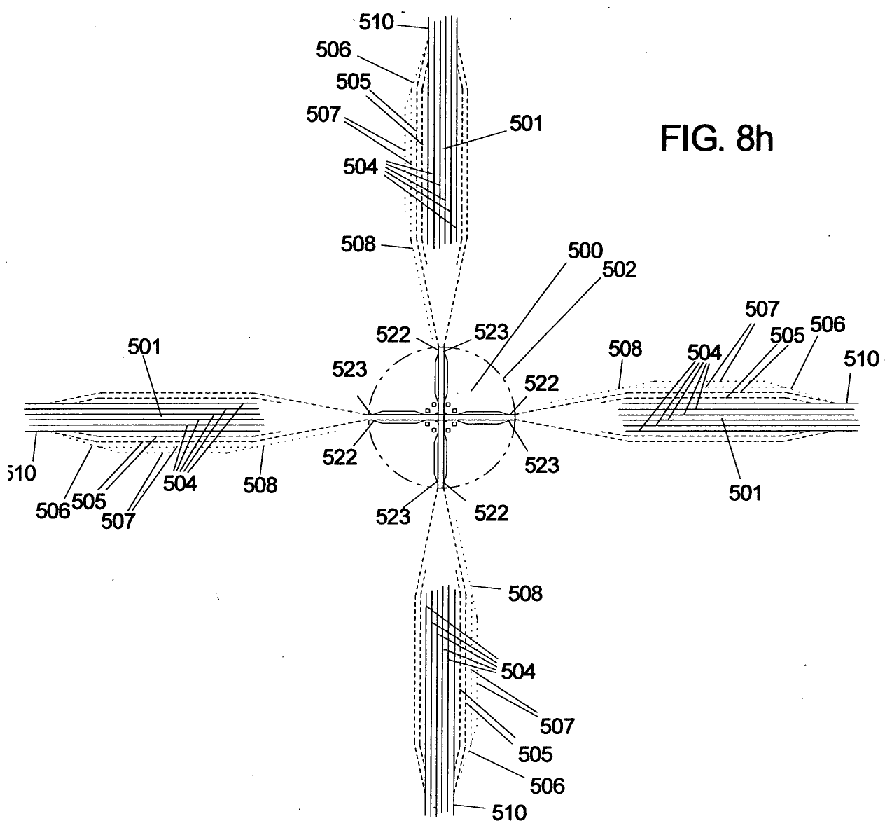

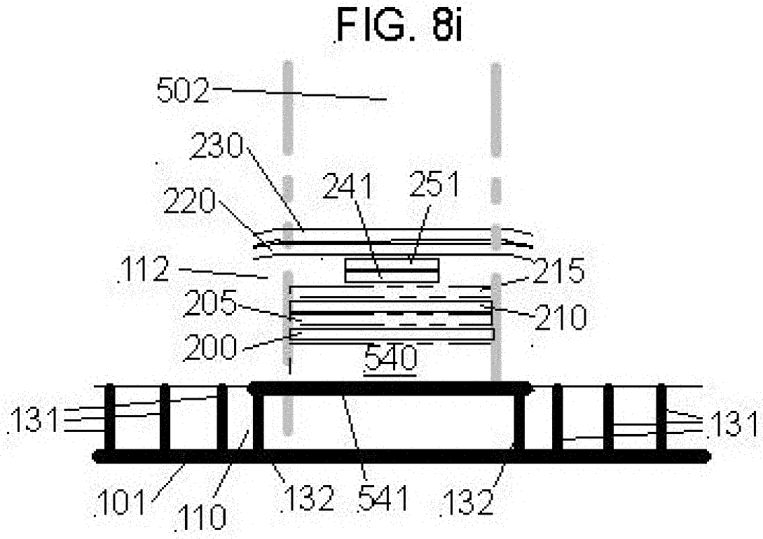

The FIG. 8 series provides more detail on the ground transportation aspect of the present invention. A later section will present starter and smaller scope variants of what is presented with reference to the FIG. 8 series.

Basic elements illustrated in the FIG. 8 series will first be introduced, followed by commentary on how these elements are interrelated.

FIG. 8 is a top view of all four approaches and a four-way intersection of two freeway-wide full installations of the ground transportation level, illustrating connecting ramp zones and the freeway-wide full intersection zone of the present invention. Note that for each right of way quadrant, 501, there are a plurality of thru lanes; as illustrated five thru lanes, 504, and all are in the same direction as the merging lanes, 510. For the full installation the basic approach is to have at least two layers of lanes in each right of way, with traffic moving in opposite directions. Each transportation level Right-Of-Way further comprises a lower thruway level, carrying a plurality of thru lanes of traffic in a first direction, and an upper thruway level, carrying a plurality of thru lanes of traffic in the opposite direction to the said lower thruway level. The transportation level intersection Right-Of-Ways further comprises a first lower thruway level, carrying a plurality of thru lanes of traffic in a first direction, a first upper thruway level, carrying a plurality of thru lanes of traffic in the opposite direction to the said first lower thruway level, a second lower thruway level intersecting the first lower thruway level, carrying a plurality of thru lanes of traffic in a first direction, and a second upper thruway level intersecting the first lower thruway level, carrying a plurality of thru lanes of traffic in an opposite direction to the said second lower thruway level. The freeway-wide full intersection illustrated in FIG. 8 comprises a full installation intersection, 500, a full installation intersection zone, 502, five full installation thru lanes, 504, full installation level changing lanes, 505, a full intersection vehicle elevator entrance lane, 506, a full intersection vehicle elevator, 507, a full intersection vehicle elevator exit and merge lane, 508, a full to intersection merging lane, 510, and a full from intersection merging lane, 512.

FIG. 8a is a top view of a Right-Of-Way quadrant section of the lower thruway level of a freeway-wide full installation approaching an intersection of the present invention, comprising a full installation approach, 501, a full installation intersection zone, 502, full installation thru lanes, 504, full installation level changing lanes, 505, a full intersection vehicle elevator entrance lane, 506, a full intersection vehicle elevator, 507, a full intersection vehicle elevator exit and merge lane, 508, and an elevator full intersection merging lane, 510.

More generally, each intersection comprises a plurality of Right-Of-Way quadrants, each said quadrant further comprises a full installation approach, a full installation intersection, full installation thru lanes, full installation level changing lanes, a full installation intersection zone, full installation thru lanes, full installation level changing lanes, a full intersection vehicle elevator entrance lane, a full intersection vehicle elevator, a full intersection vehicle elevator exit and merge lane, and a full to intersection merging lane.

FIG. 8b is a top view of a section of the upper thruway level of a freeway-wide full installation approaching an intersection of the present invention, comprising a full installation approach, 501, a full installation intersection zone, 502, full installation thru lanes, 504, full installation level changing lanes, 505, a full intersection vehicle elevator entrance lane, 506, a full intersection vehicle elevator, 507, a full intersection vehicle elevator exit and merge lane, 508, and a full to intersection merging lane, 510.

As we have noted, traffic in each full installation typically includes two levels of right of way. FIG. 8a illustrated the lower level; referring now to FIG. 8b, this is a top view of a section of the upper thruway level of a freeway-wide full installation approaching an intersection of the present invention, comprising a full installation approach, 501, a full installation intersection zone, 502, full installation thru lanes, 504, full installation level changing lanes, 505, a full intersection vehicle elevator entrance lane, 506, a full intersection vehicle elevator, 507, a full intersection vehicle elevator exit and merge lane, 508, and a full to intersection merging lane, 510.

Full implementation intersections typically have a plurality of levels for both traffic that stops, including transit, and vehicles that are dropping off and/or picking up people and/or packages. Most of the traffic at an intersection will simply proceed unimpaired using the grade-separated scheme that is a characteristic of industry-standard freeway cloverleafs, but with two (sometimes more) traffic levels for each intersecting right of way instead of one. We will next consider turning and stopping.

FIG. 8c is a top view of turning lanes for one quadrant of a turning level of a freeway-wide full installation intersection of the present invention, comprising a full installation intersection zone, 502, a turning layer, 590, a pedestrian buffer, 591, approach lanes, 592, intersection exit lanes, 593, a right turn lane, 594, a left turn lane path, 595, and an inner intersection circle, 596.

More generally, each said Right-Of-Way quadrant further comprises one or a plurality of turning levels, each turning level further comprising a full installation intersection zone, a turning layer, a pedestrian buffer, an approach lane, an intersection exit lane, a right turn lane, and a left turn lane path.

FIG. 8d is a top view of turning lanes for all quadrants of a turning level of a freeway-wide full installation intersection of the present invention, comprising a full installation intersection zone, 502, people elevator ROWs, 525, (ROW is an acronym for right of way), a turning layer, 590, a pedestrian buffer, 591, intersection entrance lanes, 592, intersection exit lanes, 593, right turn lanes, 594, left turn lane paths, 595, and an inner intersection circle, 596.

FIG. 8d-1 is a top view of an enhanced layout for turning lanes for all quadrants of a turning level of a freeway-wide full installation intersection of the present invention, comprising a full installation intersection zone, 502, intersection people elevators, 524, brief stop parking quadrants, 526, brief stop quadrant entrances, 527, brief stop quadrant exits, 528, a pedestrian buffer, 591, intersection entrance lanes, 592, intersection exit lanes, 593, right turn lanes, 594, left turn lane paths, 595, an inner intersection circle, 596, and pedestrian islands, 597.

FIG. 8e is a top view of a four-way stopping level of a freeway-wide full installation intersection of the present invention, comprising a full installation intersection zone, 502, a four way intersection, 518, four way intersection controls, 521, approach lanes, 522, after stop lanes, 523, intersection people elevators, 524, and drop off bays, 534.

More generally, each said Right-Of-Way quadrant further comprises one or a plurality of stopping levels, each stopping level further comprising a full installation intersection zone, a four way intersection, a plurality of approach lanes, a plurality of after stop lanes, a plurality of intersection people elevators, and a plurality of drop off bays.

We will next consider how these levels work together at an intersection, to both facilitate large volumes of traffic flows, and to render turning, stopping, and transfers to and from vehicles and/or elevators to other levels at a human scale. We've already seen that the turning levels and the four way intersection levels are designed as “garden variety” smaller intersections that are found in many urban areas; these accommodate pedestrians, and all people more generally, partially by avoiding more than one entering and one exiting lane in any direction. One design principle of the present invention is that it's better to use multiple levels to maintain that human scale, in contrast with all-to-typical tendencies to do things on a larger scale. We'll next consider how these different levels work cooperatively, to, in effect add an extra dimension (multiple horizontal layers) that is absent from most multi-lane systems found in today's urban environment.

FIG. 8f is a side view of connecting ramp lanes for a section of the layers of a freeway-wide full installation approaching an intersection of the present invention, comprising a ground level, 101, a Not-a-wall architecture level, 110, a utilities level, 111, a ground transportation level, 112, side vertical columns, 131, an intersecting side vertical column, 132, a four-way stopping level, 200, a reserved—second four-way stopping level, 205, a turning level, 210, a reserved—second turning level, 215, a first lower thruway lane, 220, a first upper thruway lane, 230, a second lower thruway lane at intersection, 241, a second upper thruway lane at intersection, 251, a full installation intersection zone, 502, a full intersection merging lane, 503, a full intersection vehicle elevator entrance lane, 506, a full intersection vehicle elevator, 507, a full intersection vehicle elevator exit and merge lane, 508, full installation level changing lanes, 520, a utilities level hub, 540, and a hub support platform, 541.

One key point to emphasize is the level changing lanes, 520, which reach from the thru levels of traffic to all lower four way stop and turning levels. Because the height of individual sublevels or layers within the ground transportation level can be adjusted, over time the number of these levels can be expanded as needed. Still, as illustrated in FIG. 8f, it is a good idea to reserve space from the get-go for both a reserved—second four-way stopping level, 205, and a reserved—second turning level, 215.

FIG. 8g is a top view of the connecting ramp lanes to a turning level of a freeway-wide full installation between intersections of the present invention, comprising a full installation intersection, 500, full installation approaches, 501, a full installation intersection zone, 502, full installation thru lanes, 504, full installation level changing lanes, 505, full intersection vehicle elevator entrance lanes, 506, full intersection vehicle elevators, 507, full intersection vehicle elevator exit and merge lanes, 508, full to intersection merging lanes, 510, intersection to merging lanes, 512, and intersection from merging lanes, 513.

FIG. 8h is a top view of the connecting ramp lanes to a four-way stopping level of a freeway-wide full installation between intersections of the present invention, comprising a full installation intersection, 500, full installation approaches, 501, a full installation intersection zone, 502, full installation thru lanes, 504, full installation level changing lanes, 505, full intersection vehicle elevator entrance lanes, 506, full intersection vehicle elevators, 507, full intersection vehicle elevator exit and merge lanes, 508, full to intersection merging lanes, 510, approach lanes, 522, and after stop lanes, 523.

FIG. 8i is a side view of ground transportation level sublevels at a four-way intersection of two freeway-wide full installations of the ground transportation level of the present invention, comprising a ground level, 101, a Not-a-wall architecture level, 110, a ground transportation level, 112, side vertical columns, 131, intersecting side vertical columns, 132, a four-way stopping level, 200, a reserved—second four-way stopping level, 205, a turning level, 210, a reserved—second turning level, 215, a first lower thruway level, 220, a first upper thruway level, 230, a second lower thruway level at intersection, 241, a second upper thruway level at intersection, 251, a full installation intersection zone, 502, a utilities level hub, 540, and a hub support platform, 541.

Referring now to FIG. 8i, we see that a standard full implementation of an intersection of the present invention typically involves eight levels of traffic, including four levels, 220, 230, 241 and 251, that each have multiple lanes moving in the same direction, and including two reserved levels, 205 and 215. Referring now to FIG. 8, each of these four levels comprises five thru lanes, 504, all moving in the same direction. Because many of the vehicles can be transit vehicles, the traffic handling capacity of this intersection is very high. Referring now to FIG. 8, a standard full implementation of an intersection of the present invention can also have up to four levels dedicated exclusive to vehicles that are turning and/or stopping. Because up to two of the turning levels are traffic circles, this intersection also has a very high capacity for accommodating turning. Because up to two of the levels are four way stopping levels, with only one lane entering and exiting the intersection in each direction, these levels can also accommodate an exceptionally high volume of transit vehicles. Beyond that, the turning and stopping levels are at a human scale—a major contribution to the quality of life.

Because the entire system will have only automated, self-driving vehicles, operating in a highly design constrained environment, the ability to use computer software to optimize the flow of traffic will also be very great. Referring now to FIG. 8, for the levels with five thru lanes of traffic, it will also be possible to gradually increase the speed at each level, so each right of way can accommodate a mix of flow from the range of 20 to 30 miles per hour for local traffic, to up to 90 miles an hour or more for people travelling longer distances. Beyond that speed, over time the airplane level will develop more fully.

Because the entire ground transportation system allows only light vehicles, the infrastructure itself can be light. Because the height of individual levels and sublevels is adjustable, upgrades will be far less expensive and far less disruptive than the current state of the art for surface transportation. The overall plan for this system is to build and expand it in a way, primarily through access fees for individual drivers, that will allow the system to pay for itself as it grows, partly from bond financing based on projections of system growth. The key point is to ensure as a matter of pricing and design priorities that there will be no congestion—this will make the system highly competitive with existing ground-based systems, both for transit and for individual rate paying drivers.

Vehicle moving elevators will play a critical role in the system, especially at the outset when they will be bringing in customers willing to pay to escape gridlock. However, with self-driving technology as our inevitable future, over time we can anticipate that many individual and small group vehicles will remain in the system most of the time, functioning in a transit-as-a-service mode. It is important to emphasize that vehicles using the present invention can be operated in automated-driving mode while in structures of the present invention, but can be driven manually while operating on existing surface transportation infrastructure.

### Preferred Embodiment of a Starter System Installation

We'll first introduce three illustrations relevant to this embodiment, and then proceed with analysis and exposition.

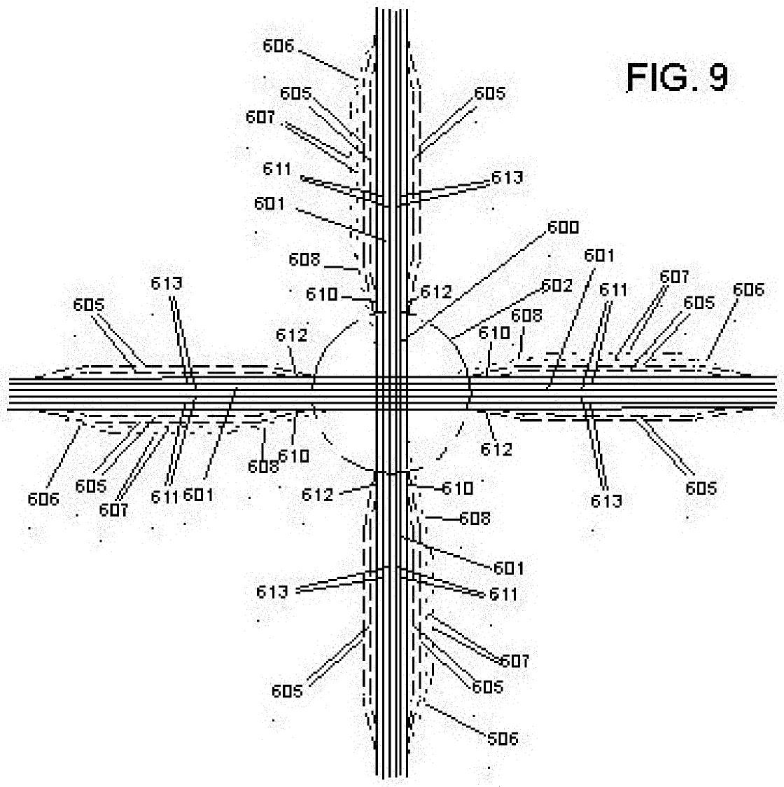

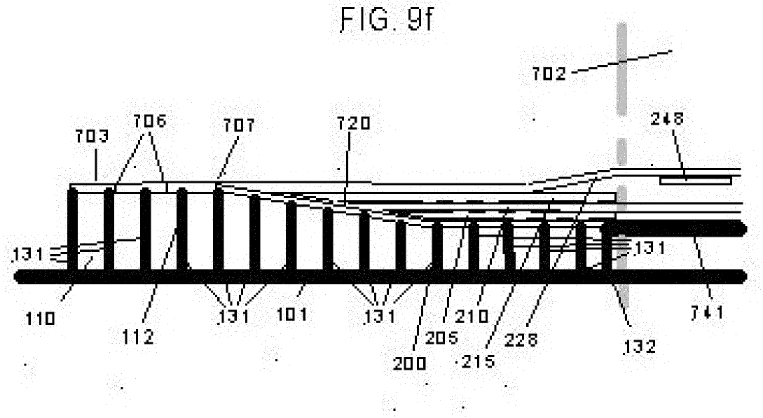

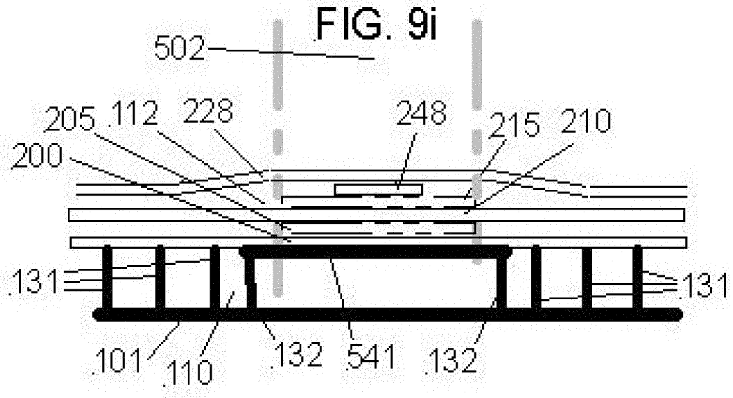

FIG. 9 is a top view of all four starter Right-Of-Way approaches and a four-way intersection of a starter installation of the ground transportation level, illustrating connecting ramp zones and the freeway-wide full intersection zone of the present invention, comprising a starter installation intersection, 600, starter installation approaches, 601, a starter installation intersection zone, 602, starter installation level changing lanes, 605, starter intersection vehicle elevator entrance lanes, 606, starter intersection vehicle elevators, 607, starter intersection vehicle elevator exit and merge lanes, 608, starter to intersection merging lanes, 610, starter to intersection thru lanes in a first direction, 611, starter from intersection merging lanes, 612, a starter from intersection thru lanes in a second opposite direction, 613.

Although FIG. 9 illustrates two thru lanes, 611 and 613, in both directions, it can be rendered with one thru lane in each direction, or with up to three thru lanes, including one reversible direction lane to accommodate predictable situations for rush hours in some locations. Elevators, 607, elevator lanes, 606 and 608, and level changing lanes, 605 and 606, all function similarly to their counterparts illustrated in the FIG. 8 series. Although FIG. 9 illustrates two level changing lanes in each direction, 605 and 606, it can be rendered with only one level changing lane in each direction. Although FIG. 9 illustrates for each direction two starter extended intersection vehicle elevators, 607, each of which can accommodate multiple vehicles on a single trip to or from ground level, it can be rendered with only one vehicle elevator.

FIG. 9f is a side view of connecting ramp lanes for a section of the levels of starter installation approaching a four-way intersection of the present invention, comprising a ground level, 101, a Not-a-wall architecture level, 110, a ground transportation level, 112, side vertical columns, 131, an intersecting side vertical column, 132, a four-way stopping level, 200, a reserved—second four-way stopping level, 205, a turning level, 210, a reserved—second turning level, 215, a first thruway level, 228, a second thruway level, 248, a starter intersection zone, 702, a starter intersection merging lane, 703, a starter intersection vehicle elevator entrance lane, 706, a starter intersection vehicle elevator, 707, a starter installation level changing lane, 720, and a hub support platform, 741. It should be noted that while a utilities level and a utilities hub are not illustrated, the entire ground transportation level, 112, can be rendered at a higher elevation to accommodate a starter utilities level, either when it is initially constructed, or at a later time, by extending the height of the side vertical columns, 131, and adjusting the elevation of the entire structure upward. Alternatively, starter Right-Of-Ways at a starter intersection can comprise reserved space for a utilities level.

The starter installation level changing lanes, 720, function in the same way as described, referring now to FIG. 8f, as their counterparts, 520, as described in the FIG. 8 series. When comparing FIG. 8f to FIG. 9f, note that because, referring now to FIG. 9, all thru lanes, 611 and 613, are on the same level, referring now to FIG. 9f, there is only one approach level, profiled by the starter intersection merging lane, 703, as the intersection is approached from any direction, or left in any direction. At the right of FIG. 9f, in a starter intersection zone, 702, the presence of only two levels, 228 and 248, emphasizes this point. It should also be noted that the ground transportation sublayers of starter installations can also be modified after initial construction to accommodate two layers with traffic moving in opposite directions, allowing four lanes of traffic moving in each direction.

FIG. 9i is a side view of sublevels at a four-way intersection of two starter installations of the ground transportation level of the present invention, comprising a ground level, 101, a Not-a-wall architecture level, 110, a ground transportation level, 112, side vertical columns, 131, intersecting side vertical columns, 132, a four-way stopping level, 200, a reserved—second four-way stopping level, 205, a turning level, 210, a reserved—second turning level, 215, a first thruway level, 228, a second thruway level, 248, a full installation intersection zone, 502, and a hub support platform, 541. Comparing FIG. 8i to FIG. 9i, we see that in FIG. 9i there are only six total levels at the intersection, rather than the eight total levels of FIG. 8I. Thus, narrower starter installations of the ground transportation level of the present invention are simpler and less expensive to build. Many if not most or all full implementations of the present invention may initially be starter installations, which can be expanded to full implementations with minimal disruption when and as needed.

More generally, the starter system can be thought of as a grid of a plurality of above ground level, multi-level Right-Of-Ways and/or starter Right-Of-Ways, further comprising one or a plurality of starter intersections. Each said starter Right-Of-Way further comprises a Not-a-wall level, a utilities level or reserved space for a utilities level, and a transportation level. Each starter Right-Of-Way transportation level further comprises a thruway level, carrying one or a plurality of thru lanes of traffic in a first direction, and one or a plurality of thru lanes of traffic in the opposite direction, Each said starter intersection further comprises two intersecting starter Right-Of-Ways. Each said starter intersection further comprises a plurality of quadrants; each said quadrant further comprises a plurality of starter installation approaches, a starter intersection, a plurality of starter Right-Of-Way thru lanes, a plurality of starter Right-Of-Way level changing lanes, a starter intersection zone, a plurality of starter Right-Of-Way level changing lanes, a plurality of starter Right-Of-Way vehicle elevator entrance lanes, a plurality of starter Right-Of-Way vehicle elevators, a plurality of starter Right-Of-Way vehicle elevator exit and merge lane, and a plurality of elevator to starter Right-Of-Way merging lanes. Each said starter Right-Of-Way quadrant further comprises one or a plurality of turning levels, each turning level further comprising a starter intersection zone, a turning layer, a pedestrian buffer, an approach lane, a starter intersection exit lane, a right turn lane, and a left turn lane path. Each said starter Right-Of-Way quadrant further comprises one or a plurality of stopping levels, each stopping level further comprising a starter intersection zone, a four way intersection, a plurality of approach lanes, a plurality of after stop lanes, a plurality of intersection people elevators, a plurality of drop off bays, and a plurality of level changing lanes, which reach from the thru levels of traffic to all lower four way stop and turning levels.

For all implementations, frequent elevator links between the ground transportation level and ground level—spaced about every eighth of a mile—and the ability to use corresponding vehicle transfer bays to move between on-demand automated vehicle mode and manually driven mode at all elevator locations, will facilitate easy use of the transit services of the present invention with existing transportation infrastructure. The combination of ultra-frequent transit service from automated vehicles, at intervals of five minutes or less, combined with revenue from drivers who put a premium on no congestion, should result in both very rapid increases in transit use, with corresponding revenue, and also a rapid increase in use of the system by personal vehicles that can operate in both automated and manual modes; the result should be enough incoming revenue to fund the rapid expansion of implementations of the present invention in large metropolitan areas.

Although it is not essential to include a parks level above starter installations of the ground transportation level, doing so immediately is highly advisable. It will be inexpensive and will reinforce the idea that the present invention enhances the quality of life. People will really appreciate the unique experiences of being able to bike, or scooter, or ride a horse, with amazing treetop views, for miles in any direction in major metropolitan areas, completely free of interactions with cars and larger vehicles, in a parklike setting, and sheltered from the elements. Of course, the entire system will be closely integrated with existing urban park systems. This brings us to our final topic.

### People, Trees and Structures: A Comment on the Essential Role of Landscape Architecture

The world famous Minneapolis Park System is an amazing example of landscape architecture generally, but the design of Loring park is particularly interesting because of how landscape architecture was deliberately used to render a large park area, seemingly rural at the time, within a few blocks of what was a developing major metropolitan area. From an individual's point of view, the fact that trees are much taller than we are allows for a strategic placement of trees to present people with what can appear to be an exurban, or rural, or even almost a forest like environment to people, even though there may be structures as high as twenty stories, or even more, only a block or two away. It is for this reason that implementations of the present invention can be and should be implemented with both a long time perspective, and with a fully developed landscape architecture plan to render such environments for people decades and centuries from now. We need to keep in mind that as the implementation of the present invention becomes both widespread and dominant, the nature of street level traffic on what are now our grid of surface level transportation will change dramatically. In short, we can have high density urbanism coexisting together with neighborhoods that increasingly take on an exurban, or even somewhat rural character. This will maintain or increase property values for such existing neighborhoods, while allowing what amounts to the development of entirely new third millennium cities, covering the same geographic areas as existing cities, but with far lower transportation and housing costs. As noted, the use of taxes can protect the investment value of existing cities and their infrastructure, while providing low cost transportation, transit and housing for people who need these things.

To sum up: Why not!

What is claimed is:

1. A grid of a plurality of above ground level, multi-level Right-Of-Ways, further comprising one or a plurality of intersections. Each said Right-Of-Way further comprises a Not-a-wall level, a utilities level, and a transportation level. Each transportation level Right-Of-Way further comprises a lower thruway level, carrying a plurality of thru lanes of traffic in a first direction, and an upper thruway level, carrying a plurality of thru lanes of traffic in the opposite direction to the said lower thruway level. The transportation level intersection Right-Of-Ways further comprises a first lower thruway level, carrying a plurality of thru lanes of traffic in a first direction, a first upper thruway level, carrying a plurality of thru lanes of traffic in the opposite direction to the said first lower thruway level, a second lower thruway level intersecting the first lower thruway level, carrying a plurality of thru lanes of traffic in a first direction, and a second upper thruway level intersecting the first lower thruway level, carrying a plurality of thru lanes of traffic in an opposite direction to the said second lower thruway level. Each said intersection further comprises a plurality of Right-Of-Way quadrants; each said quadrant further comprises a full installation approach, a full installation intersection, a plurality of full installation thru lanes, a plurality of full installation level changing lanes, a plurality of full installation intersection zones, a plurality of full installation level changing lanes, a plurality of full intersection vehicle elevator entrance lanes, a plurality of full intersection vehicle elevators, a plurality of full intersection vehicle elevator exit and merge lanes, and a plurality of elevator to full intersection merging lanes. Each said Right-Of-Way quadrant further comprises one or a plurality of turning levels, each turning level further comprising a full installation intersection zone, a turning layer, a pedestrian buffer, an approach lane, an intersection exit lane, a right turn lane, and a left turn lane path. Each said Right-Of-Way quadrant further comprises one or a plurality of stopping levels, each stopping level further comprising a full installation intersection zone, a four way intersection, a plurality of approach lanes, a plurality of after stop lanes, a plurality of intersection people elevators, a plurality of drop off bays, and a plurality of level changing lanes, which reach from the thru levels of traffic to all lower four way stop and turning levels.

2. The grid of a plurality of above ground level, multi-level Right-Of-Ways, further comprising intersections, of claim 1, further comprising a parks level.

3. The grid of a plurality of above ground level, multi-level Right-Of-Ways, further comprising intersections, of claim 1, further comprising a housing level.

4. The grid of a plurality of above ground level, multi-level Right-Of-Ways, further comprising intersections, of claim 1, further comprising an energy roof level.

5. The grid of a plurality of above ground level, multi-level Right-Of-Ways, further comprising intersections, of claim 1, further comprising an airplane level.

6. The grid of a plurality of above ground level, multi-level Right-Of-Ways, further comprising intersections, of claim 1, further comprising a heavy lift level, the said heavy lift level further comprising a heavy lift track, an extensible moving lift module, and a forklift structure.

7. A grid of a plurality of above ground level, multi-level Right-Of-Ways and/or starter Right-Of-Ways, further comprising one or a plurality of starter intersections. Each said starter Right-Of-Way further comprises a Not-a-wall level, a utilities level or reserved space for a utilities level, and a transportation level. Each starter Right-Of-Way transportation level further comprises a thruway level, carrying one or a plurality of thru lanes of traffic in a first direction, and one or a plurality of thru lanes of traffic in the opposite direction, Each said starter intersection further comprises two intersecting starter Right-Of-Ways. Each said starter intersection further comprises a plurality of quadrants; each said quadrant further comprises a plurality of starter installation approaches, a starter intersection, a plurality of starter Right-Of-Way thru lanes, a plurality of starter Right-Of-Way level changing lanes, a starter intersection zone, a plurality of starter Right-Of-Way level changing lanes, a plurality of starter Right-Of-Way vehicle elevator entrance lanes, a plurality of starter Right-Of-Way vehicle elevators, a plurality of starter Right-Of-Way vehicle elevator exit and merge lane, and a plurality of elevator to starter Right-Of-Way merging lanes. Each said starter Right-Of-Way quadrant further comprises one or a plurality of turning levels, each turning level further comprising a starter intersection zone, a turning layer, a pedestrian buffer, an approach lane, a starter intersection exit lane, a right turn lane, and a left turn lane path. Each said starter Right-Of-Way quadrant further comprises one or a plurality of stopping levels, each stopping level further comprising a starter intersection zone, a four way intersection, a plurality of approach lanes, a plurality of after stop lanes, a plurality of intersection people elevators, a plurality of drop off bays, and a plurality of level changing lanes, which reach from the thru levels of traffic to all lower four way stop and turning levels.

8. The grid of a plurality of above ground level, multi-level Right-Of-Ways and/or starter Right-Of-Ways, further comprising one or a plurality of starter intersections of claim 7, further comprising a parks level.

9. The grid of a plurality of above ground level, multi-level Right-Of-Ways and/or starter Right-Of-Ways, further comprising one or a plurality of starter intersections of claim 7, further comprising a housing level.

10. The grid of a plurality of above ground level, multi-level Right-Of-Ways and/or starter Right-Of-Ways, further comprising one or a plurality of starter intersections of claim 7, further comprising an energy roof level.

11. The grid of a plurality of above ground level, multi-level Right-Of-Ways and/or starter Right-Of-Ways, further comprising one or a plurality of starter intersections of claim 7, further comprising an airplane level.

12. The grid of a plurality of above ground level, multi-level Right-Of-Ways and/or starter Right-Of-Ways, further comprising one or a plurality of starter intersections of claim 7, further comprising a heavy lift level, the said heavy lift level further comprising a heavy lift track, an extensible moving lift module, and a forklift structure.
